(19) United States
(12) Patent Application Publication
(10) Pub. No.: US 2025/0125551 A1
(43) Pub. Date: Apr. 17, 2025

(54) ELECTRICAL CONNECTOR

(71) Applicant: Neoconix, Inc., San Jose, CA (US)

(72) Inventors: David Chen, Los Altos, CA (US); Woody Maynard, State College, PA (US)

(21) Appl. No.: 18/488,013

(22) Filed: Oct. 16, 2023

(51) Int. Cl. H01R 13/24; H01R 12/71; H01R 12/73

(52) U.S. Cl. CPC H01R 13/2492; H01R 12/714; H01R 12/73; H01R 13/2414; H01R 13/2421; H01R 13/2435

(57) ABSTRACT

An electrical connector includes a contact element layer including an array of contact elements. Each contact element includes a base portion and first and second elastic arm portions provided on opposing sides of the base portion, the sides of the base portion being in a direction along a planar surface of the base portion. The first and second elastic arm portions are compliant spring elements and extend in opposite first and second directions relative to the base portion, the first and second directions being perpendicular to the planar surface of the base portion.

### FIELD OF THE INVENTION

The invention relates to reconnectable, remountable electrical connectors, and, in particular, to an electrical connector including contact elements constructed with a monolithic body including a base portion and elastic arm portions extending therefrom.

### BACKGROUND OF THE INVENTION

Electrical interconnects or connectors are used to connect two or more electronic components together or to connect an electronic component to a piece of electrical equipment, such as a computer, router, or tester. For instance, an electrical connector is used to connect an electronic component, such as an integrated circuit (an IC or a chip), to a printed circuit broad. An electrical connector is also used during integrated circuit manufacturing for connecting an IC device under test to a test system. In some applications, the electrical interconnect or connector provides separable or remountable connection so that the electronic component attached thereto can be removed and reattached. For example, it may be desirable to mount a packaged microprocessor chip to a personal computer mother board using a separable interconnect device so that malfunctioning chips can be readily removed or upgraded chips can be readily installed.

The ability to make separable electrical contact with contacts of semiconductor scale electronic circuits has become more problematic as the mechanical, electrical, and reliability requirements of these electrical contacts become more demanding. Nano springs, pogo pins, micro springs, and other miniature contact devices have been developed to deal with the problem of making reliable electrical contact between semiconductor integrated circuits or between a semiconductor integrated circuit and an electronic system, such as one built on a printed circuit board (PCB). In some examples, conventional electrical connectors are made of stamped metal springs, which are formed and then individually inserted into an insulating carrier to form an array of electrical connector elements. Other approaches to making electrical connectors include using isotropically conductive adhesives, injection molded conductive adhesives, bundled wire conductive elements, springs formed by wire bonding techniques, and small solid pieces of metal.

Land grid array (LGA) refers to an array of metal pads (also called lands) that are used as the electrical contact points for an integrated circuit package, a printed circuit board, or other electronic component. The metal pads are usually formed by lithographically defining and etching them on an insulating surface or substrate. It is common to then coat the surface with a gold film or other noble metal to provide a non-oxidizing surface. Ball Grid array (BGA) refers to an array of solder balls or solder bumps that are used as the electrical contact points for an integrated circuit package. Both LGA and BGA packages are widely used in the semiconductor industry and each has its associated advantages or disadvantages. For instance, LGA packages are typically cheaper to manufacture than ball grid array (BGA) packages because there is no need to form solder balls or solder bumps. However, LGA packages are typically more difficult to assemble onto a PC board or a multi-chip module. An LGA connector is usually used to provide removable and remountable socketing capability for LGA packages connected to PC boards or to chip modules

Advances in semiconductor technologies has led to shrinking dimensions within semiconductor integrated circuits and particularly, decreasing pitch for the contact points on a silicon die or a semiconductor package. The pitch, that is, the spacing between each electrical contact point (also referred to as a “lead”) on a semiconductor device is decreasing dramatically in certain applications. For example, contact pads on a semiconductor wafer can have a pitch of 250 micron or less. At the 250-micron pitch level, it is prohibitively difficult and very expensive to use conventional techniques to make separable electrical connections to these semiconductor devices. The problem is becoming even more critical as the pitch of contact pads on a semiconductor device decreases below 50 microns and simultaneous connection to multiple contact pads in an array is required.

### SUMMARY OF THE INVENTION

According to embodiments of the present disclosure, a connector for electrically connecting to conductive structures formed on an electronic component to be connected thereto includes a contact element layer including an array of contact elements. Each contact element includes a base portion and first and second elastic arm portions provided on opposing sides of the base portion, the sides of the base portion being in a direction along a planar surface of the base portion. The first and second elastic arm portions are compliant spring elements and extend in opposite first and second directions relative to the base portion, the first and second directions being perpendicular to the planar surface of the base portion.

These and other advantages, aspects and novel features of the present invention, as well as details of an illustrated embodiment thereof, will be more fully understood from the following description and drawings.

### BRIEF DESCRIPTION OF THE DRAWINGS

Various embodiments of the invention are disclosed in the following detailed description and the accompanying drawings. Although the drawings depict various examples of the invention, the invention is not limited by the depicted examples. It is to be understood that, in the drawings, like reference numerals designate like structural elements. Also, it is understood that the depictions in the figures are not necessarily to scale.

FIG. 1 is a perspective view of an electrical connector in a first embodiment of the present disclosure.

FIG. 2 is a perspective view of a contact element formed in the electrical connector of FIG. 1 according to embodiments of the present disclosure.

FIG. 3 is an exploded view of the electrical connector of FIG. 1 in embodiments of the present disclosure.

FIG. 4 is a top view of the electrical connector of FIG. 1 in some embodiments.

FIGS. 5(a), 5(b), 5(c) and 5(d) illustrate the top view, the side view, and cross-sectional views of the connector 10 of FIG. 1 in some embodiments.

FIG. 6 is a perspective view of an electrical connector in a second embodiment of the present disclosure.

FIG. 7 is an exploded view of the electrical connector of FIG. 6 in embodiments of the present disclosure.

FIG. 8 is an exploded view of the electrical connector of FIG. 6 in embodiments of the present disclosure.

FIG. 9 illustrates a top view and an enlarged cross-sectional view of the connector 50 along a line A-A′ in some embodiments.

### DETAILED DESCRIPTION OF THE INVENTION

In embodiments of the present disclosure, a separable and reconnectable electrical connector includes contact elements that are formed with a monolithic or unitary construction, each contact element including a base portion and two elastic arm portions provided on two opposing sides of the base portion. The two elastic arm portions on opposing sides of the base portion extend in opposite upward and downward directions relative to the base portion. In this manner, the elastic arm portions of the contact elements enables a contact array arrangement that realizes a low profile interconnect structure and compact dimensions.

In one embodiment, the two arm portions are symmetrical about the base portion and the arm portions have the same length dimensions. In another embodiment, the two arm portions are asymmetrical about the base portion and one of the arm portions is longer than the other arm portion. Furthermore, in some embodiments, the two arm portions are positioned with offsets in the opposition direction from a central line of the base portion.

In the present description, discussions and/or illustrations concerning directions (such as up and down or horizontal and vertical) are for convenience and are not meant to imply that the apparatus disclosed can be used in only the orientation depicted or that one orientation is preferred over another orientation. In practice, the electrical connector described herein can be applied in a horizontal, vertical or oblique orientation as desired, and the elastic arm portions of the electrical connector can be arranged in different orientations with either one of the arm portions extending upward and the other arm portion extending downward. Furthermore, in embodiments of the present invention, the electrical connector may implement various designs and geometries for the contact elements to realize the desired force for providing a given surface scrub characteristics at the contact interface to the mating electronic device.

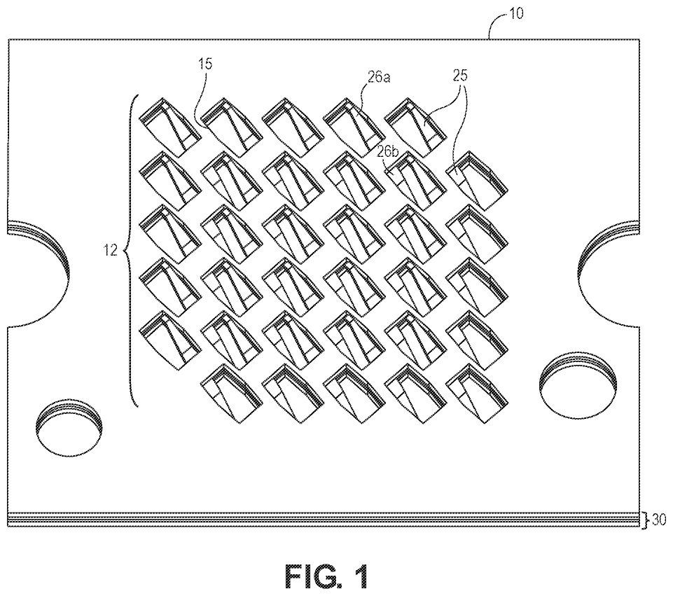

FIG. 1 is a perspective view of an electrical connector in a first embodiment of the present disclosure. In embodiments of the present disclosure, the connector is applied to use as an interposer and the terms “connector” and “interposer” may be used interchangeably in the present description. Referring to FIG. 1, a connector 10 includes a contact array 12 of contact elements 25 extending from respective openings 15 formed in the connector body 30. Each contact element 25 includes a first elastic arm portion 26a extending from a respective opening 15 on a first surface (e.g. top surface) of the connector body and a second elastic arm portion 26b extending from an adjacent opening 15 on a second, opposite surface (e.g. bottom surface) of the connector body. The second elastic arm portions 26b extending from the second surface are not shown in FIG. 1 but will be illustrated in the following figures. In the present embodiment, the contact array 12 is formed as a two-dimensional array of contact elements. The two-dimensional array configuration is illustrative only and not intended to be limiting. The contact elements 25 can be arranged in any configuration or design necessary for the components to be connected thereto. The connector 10 provides separable or remountable connection and is capable of retaining high quality electrical connection over repeated insertions.

In embodiments of the present disclosure, the contact elements 25 are formed as compliant spring contact elements. In the present embodiment, each contact element 25 is formed as metal flanges extending from a base portion. In other embodiments, other types of contact elements can be used depending on the components to which the interposer is to be connected. The contact elements used for the contact array in the connector is selected based on the type of contact structures of the component to which the electrical connector is to be coupled. In some examples, the electrical connector is to be coupled to semiconductor components and the contact elements are configured to connect to conductive pads formed on the semiconductor components.

In embodiments of the present disclosure, the connector 10 can be used to make electrical connections from components such as a Printed Circuit Board (PCB) to another PCB, to a central processing unit or microprocessor, or to a network processor unit, or to a neural processing unit, or to a graphic processing unit, or other semiconductor device. Furthermore, the electrical connector can be used to make electrical connections to electrical contact points formed on any electronic components. For example, the electrical contact points can be an array of metal pads, such as a land grid array, that are used as the electrical contact points for an integrated circuit package, a printed circuit board, or other electronic component. The electrical connector of the present disclosure can be used to connect to a land grid array formed on a printed circuit board or formed on a semiconductor chip or other devices.

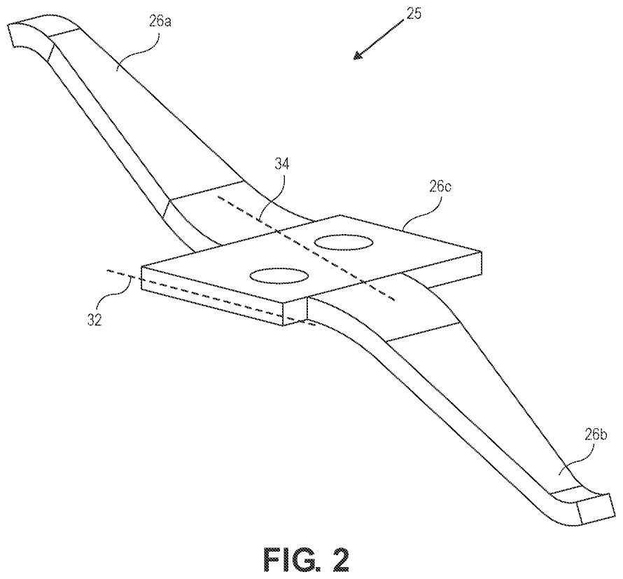

FIG. 2 is a perspective view of a contact element formed in the electrical connector of FIG. 1 according to embodiments of the present disclosure. Referring to FIG. 2, a contact element 25 has a monolithic or unitary construction and is formed from a single-piece conductive material, such as a metal layer. The contact element 25 includes a base portion 26c and a first elastic arm portion 26a and a second elastic arm portion 26b extending from opposing sides of the base portion 26c. In the present embodiment, the first elastic arm portion 26a extends in an upward direction from the base portion 26c and the second elastic arm portion 26b extends in a downward direction from the base portion 26c. As noted above, the terms “upward” and “downward” (or “up” and “down”) are used in the present disclosure for ease of description and do not refer to specific direction or orientation or specific arrangement of layers. The use of the terms “upward” and “downward” (or “up” and “down”) in the present description is illustratively only and is not intended to be limiting. In general, the terms upward and downward refers to opposition directions that are perpendicular to the planar surface of the base portion.

More specifically, in the present embodiment, the first elastic arm portion 26a extends in a first direction along a planar surface of the base portion 26c (as indicated by the dotted line 32) and the second elastic arm portion 26b extends in a second direction along the planar surface of the base portion 26c that is opposite to the first direction. In other words, the first elastic arm portion 26a extends from a first side of the base portion 26c while the second elastic arm portion 26b extends from a second, opposition, side of the base portion 26c. As thus configured, the two elastic arm portions and the base portion of the contact element 25 form an S-shaped structure and the contact element 25 is sometimes referred herein as an S-beam. In one embodiment, the contact element 25 is formed of [what is the material] and the elastic arm portions are formed as stamped metal springs.

In the present embodiments, the two arm portions are positioned with offsets in the opposition direction from a central line 34 of the base portion. For example, the first elastic arm portion 26a is offset to the right of the central line 34 and the second elastic arm portion 26b is offset to the left of the central line 34.

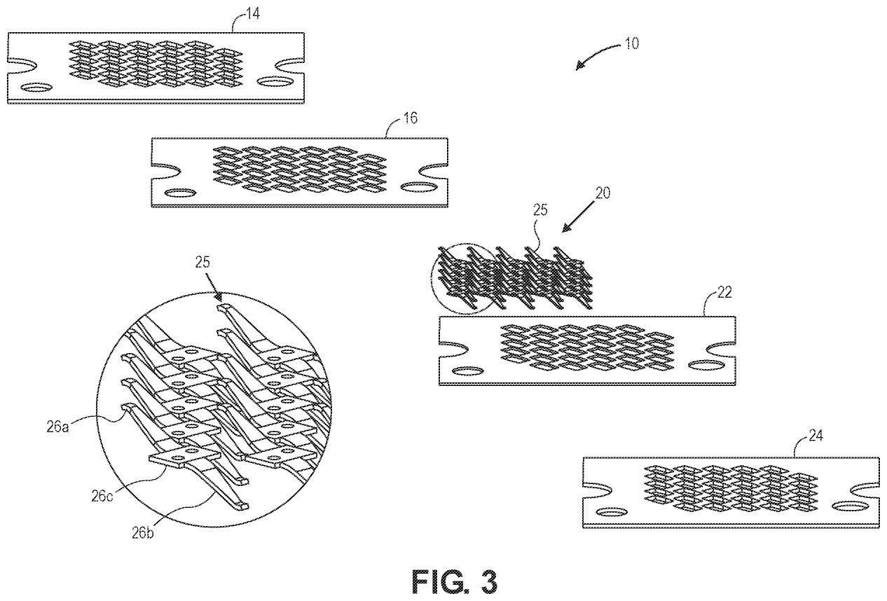

FIG. 3 is an exploded view of the electrical connector of FIG. 1 in embodiments of the present disclosure. Referring to FIG. 3, in some embodiments, the construction of the connector 10 of the present disclosure includes a top coverlay isolation layer 14, a top adhesive layer 16, a contact element layer 20 with contact elements 25 formed thereon, a bottom adhesive layer 22, and a bottom coverlay isolation layer 24. The top or bottom coverlay isolation layer 14, 24 is applied to encapsulate the connector 10, with openings to expose the spring elements of the contact elements 25. In some embodiments, the coverlay isolation layer may be a thin, semi-rigid material. Top adhesive layer 16 is applied to attach the top coverlay isolation layer to the top surface of the contact element layer 20. The bottom adhesive layer 22 is applied to attach the bottom coverlay isolation layer 24 to the bottom surface of the contact element layer 20. In some embodiments, the contact element layer 20 includes contact elements 25 formed on a substrate with the elastic arm portions of the contact elements being formed as stamped metal springs.

It is instructive to note that the terms “top” and “bottom” are used in the present disclosure for ease of description and do not refer to specific direction or orientation or specific arrangement of layers. It is understood that electrical connector of the present disclosure has a first surface which can be referred to as the top surface and a second surface, opposite the first surface, which can be referred to as the bottom surface. The use of the terms “top” and “bottom” in the present description is illustratively only and not intended to be limiting.

The insert in FIG. 3 illustrates the array of contact elements 25 formed in the contact element layer. With the contact element 25 in the S-beam configuration, the base portions 26c of the contact elements are arranged staggered in a row. The first elastic arm portion 26a of each contact element 25 extends in an upward direction to protrude beyond an opening in the top coverlay isolation layer 14. The second elastic arm portion 26b of the respective contact element 25 extends in a downward direction to protrude beyond an opening in the bottom coverlay isolation layer 24. In the present embodiment, the top coverlay isolation layer has a first set of openings and the bottom coverlay isolation layer has a second set of openings that are aligned with the first set of openings. As thus configured, the first elastic arm portion 26a of a given contact element protrudes beyond a first opening of the top coverlay isolation layer while the corresponding second elastic arm portion 26b protrudes beyond a second opening of the bottom coverlay isolation layer. The second opening in the bottom coverlay isolation layer is adjacent to an opening that corresponds to the first opening in the top coverlay isolation layer and the first and second openings are aligned along a central line of the base portion.

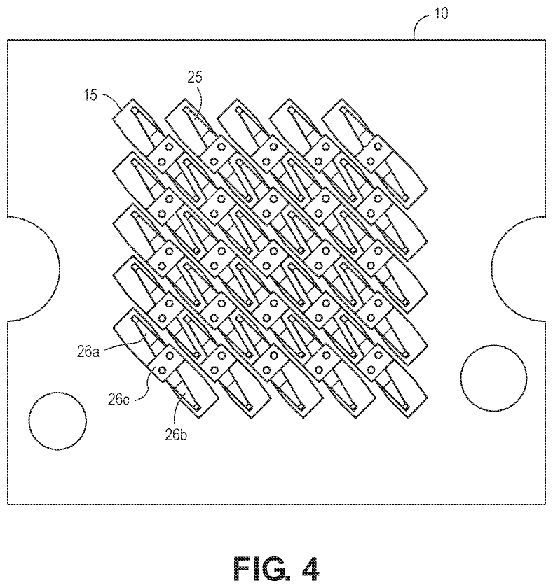

FIG. 4 is a top view of the electrical connector of FIG. 1 in some embodiments. Specifically, FIG. 4 illustrates the connector 10 with the top coverlay isolation layer and the top adhesive layer removed to reveal the contact element layer in the openings made in the bottom adhesive layer and the bottom coverlay isolation layer. Referring to FIG. 4, the contact array includes contact elements 25 arranged in a two-dimensional array. Each contact element 25 includes a base portion 26c with two elastic arm portions 26a, 26b extending from opposing sides. In the present embodiment, the two elastic arm portions 26a and 26b are positioned offset from each other along a central line of the base portion. As thus configured, within the same opening, the first elastic arm portion 26a of a given contact element protrudes upwards in a first opening while the second elastic arm portion 26b of an adjacent contact element protrudes downwards. Meanwhile, the first elastic arm portion 26a of a given contact element protrudes upwards the first opening and the second elastic arm portion 26b of the same contact element protrudes downwards in a second, adjacent opening.

In some embodiments of the present disclosure, planar contact elements are first formed in a thin conductive plane or a sheet of elastic material provided on a substrate. The substrate has openings corresponding to locations of the planar contact elements. The resultant planer compliant spring elements are then mechanically formed upward and downward and away from the surface of the conductive sheet of elastic material, forming the three-dimensional features of the contact elements. In some examples, each contact element includes a base portion and two compliant spring portions, also referred to as flanges or probes, that extend from the base portion to form the elastic arm portions. In the present embodiment, each contact element 25 includes a first elastic arm portion that extends upward to form a compliant spring contact element on the top surface of the connector and a second elastic arm portion that extends downward to form a compliant spring contact element on the bottom surface of the connector. The substrate with the sheet of the contact elements is referred herein as the contact element layer 20. In the present embodiment, the contact elements 25 are arranged to form a two-dimensional array of contact elements in the contact element layer 20. The contact element layer 20, with the contact elements 25, is attached to the top coverlay isolation layer 14 using the top adhesive layer 16, and is further attached to the bottom coverlay isolation layer 24 using the bottom adhesive layer 22 (FIG. 3). In other embodiments, the contact elements can be formed using any process currently known or to be developed. In some embodiments, the top and bottom coverlay isolation layers 14, 24 are optional and may be omitted in other embodiments.

It is instructive to note that the exploded view of FIG. 2 and other exploded or deconstructed views in the following description are provided to illustrate the various layers forming the electrical connector of the present disclosure. The exploded views are not intended to illustrate the actual order of elements or the actual construction of the connector. The exploded or deconstructed views in the present description are provided for illustrative purposes only.

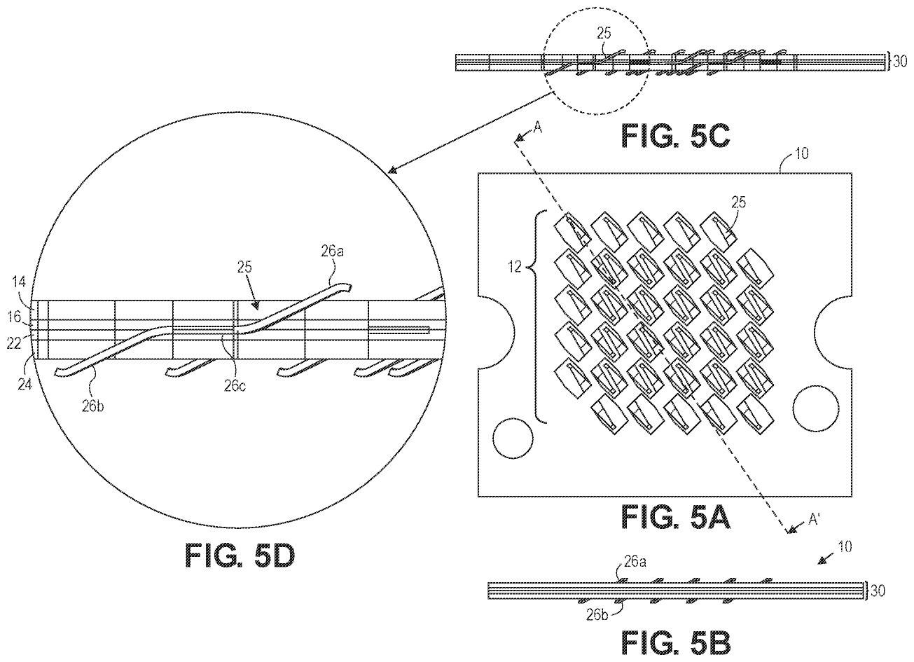

FIGS. 5(a), 5(b), 5(c) and 5(d) illustrate the top view, the side view, and cross-sectional views of the connector 10 of FIG. 1 in some embodiments. In particular, FIG. 5(a) is a top view of the electrical connector of FIG. 1 in embodiments of the present disclosure. FIGS. 5(b) is a side view of the electrical connector of FIG. 1 and FIGS. 5(c) and 5(d) are cross-sectional views of the electrical connector of FIG. 5(a) along a line A-A′ in some embodiments. FIG. 5(d) illustrates an enlarged cross-sectional view of a portion of the connector 10 in FIG. 5(c).

Referring to FIG. 5(a), the connector 10 includes the contact array 12 of contact elements 25. Referring to FIG. 5(b), the side view of the connector 10 illustrates the first elastic arm portion 26a protruding upward from the connector body 30 and the second elastic arm portions 26b protruding downward from the connector body 30 for engaging with electronic components to be connected. The first and second elastic arm portions extend to opposite directions of their respective base portions. Referring to FIGS. 5(c) and 5(d), the cross-sectional views of the connector 10 along the line A-A′ illustrate the contact elements within the connector body 30. The S-beam configuration of the contact elements 25 is shown in FIG. 5(c) and further illustrated in the enlarged view of FIG. 5(d). In particular, the base portion 26c of each contact element 25 is formed in a central portion of the connector body 30, between the top/bottom coverlay isolation layers 14, 24 and the top/bottom adhesive layers 16, 22. The first elastic arm portion 26a and the second elastic arm portion 26b extend from opposing sides of the base portion 26a and further extend in opposing upward and downward directions so that the contact element 25 assumes a letter “S” configuration. With the letter “S” configuration, the contact element 25 has an extended length so that the first elastic arm portion 26a protrudes through a first opening in the upward direction while the second elastic arm portion 26b protrudes through a second opening in the downward direction, the second opening being adjacent to an opening corresponding to the first opening and being aligned along a central line of the base portion.

In the above-described embodiments, the electrical connector includes contact elements that are symmetrically formed about the base portion. That is, the two arm portions are symmetrical about the base portion and the arm portions have the same length dimension as measured from the base portion. In another embodiment, the two arm portions are asymmetrical about the base portion and one of the arm portions is longer than the other arm portion.

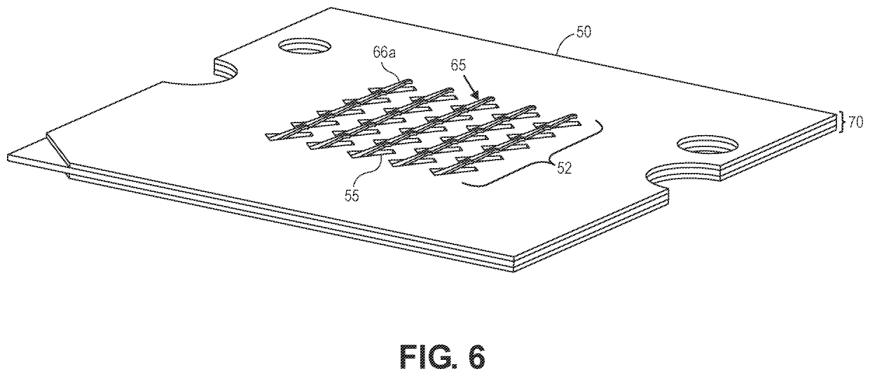

FIG. 6 is a perspective view of an electrical connector in a second embodiment of the present disclosure. Referring to FIG. 6, a connector 50 includes a contact array 52 of contact elements 65 extending from respective openings 55 formed in the connector body 70. Each contact element 65 includes a first elastic arm portion 66a extending upward from a respective opening 55 on a first surface (e.g. top surface) of the connector body 70 and a second elastic arm portion 66b extending from an adjacent opening 55 on a second, opposite surface (e.g. bottom surface) of the connector body 70. The second elastic arm portions 66b extending from the second surface are not shown in FIG. 6 but will be illustrated in the following figures. In the present embodiment, the contact array 52 is formed as a two-dimensional array of contact elements. The two-dimensional array configuration is illustrative only and not intended to be limiting. The connector 50 provides separable or remountable connection and is capable of retaining high quality electrical connection over repeated insertions.

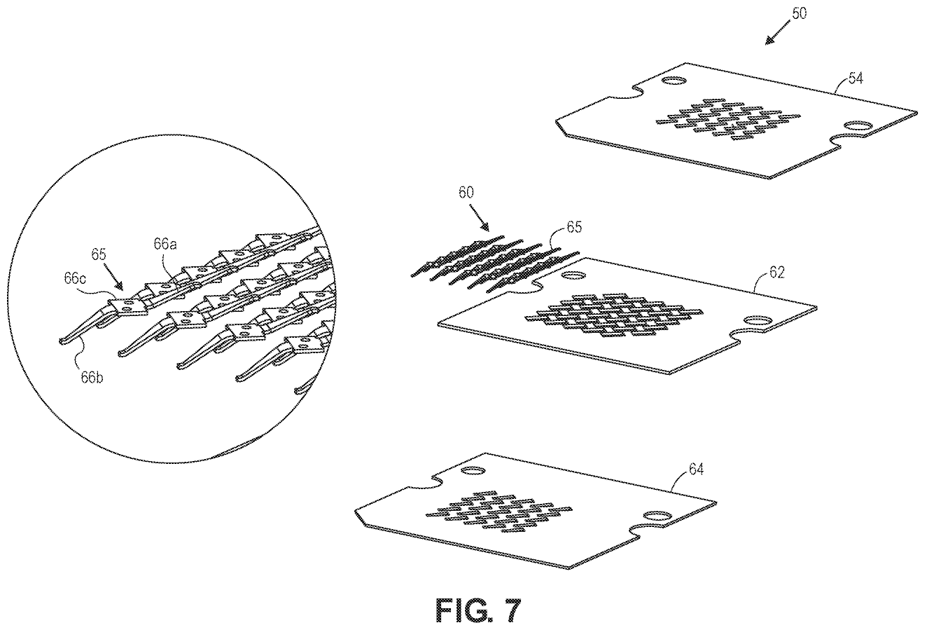

FIG. 7 is an exploded view of the electrical connector of FIG. 6 in embodiments of the present disclosure. Referring to FIG. 7, in some embodiments, the construction of the connector 50 of the present disclosure includes a top coverlay isolation layer 54, an adhesive layer 62, a contact element layer 60 with contact elements 65 formed thereon, and a bottom coverlay isolation layer 64. The top or bottom coverlay isolation layer 54, 64 is applied to encapsulate the connector 50, with openings to expose the spring elements of the contact elements 65. In some embodiments, the coverlay isolation layer may be a thin, semi-rigid material. In the present embodiment, a single adhesive layer 62 is provided to attach to the top and bottom coverlay isolation layers 54, 64. In some embodiments, the contact element layer 60 includes contact elements 65 formed on a substrate with the elastic arm portions of the contact elements being formed as stamped metal springs. The contact elements 65 thus formed are then attached to the adhesive layer 62 by positioning the base portion 66c of the contact element onto the adhesive layer 62. In the present embodiment, the second elastic arm portion 66b of the contact element is longer than the first elastic arm portion 66a.

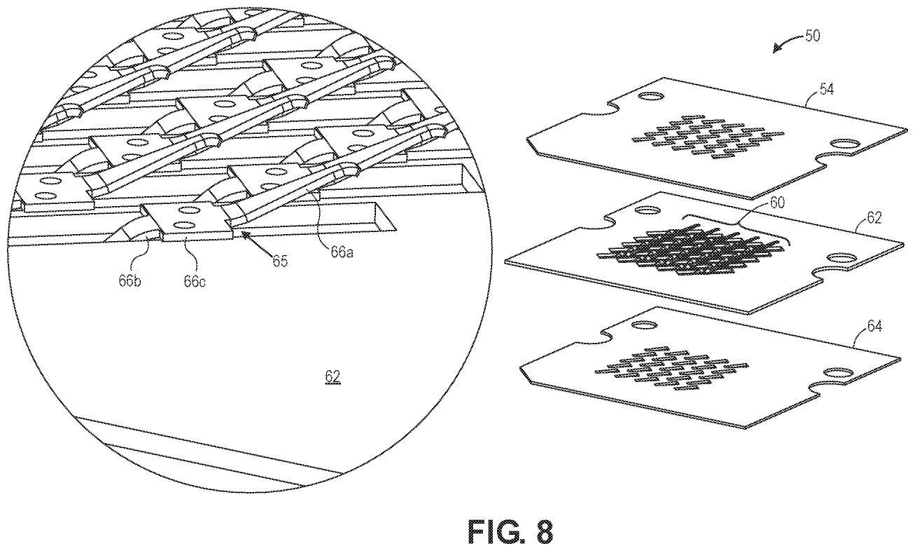

FIG. 8 is an exploded view of the electrical connector of FIG. 6 in embodiments of the present disclosure. In particular, FIG. 8 illustrates the contact elements in the contact element layer being attached to the adhesive layer 62 in some examples. Referring to FIG. 8, in connector 50, the contact elements 65 with elastic arm portions thus formed are attached to the adhesive layer 62 by positioning the base portion 66c of each contact element on the adhesive layer 62. Openings in the adhesive layer 62 allows the second elastic arm portion 66b to extend downward through the openings and then through the bottom coverlay isolation layer 64. The first elastic arm portion 66a extends above the base portion to extend upward through the openings in the top coverlay isolation layer 54. As thus configured, the second elastic arm portion 66b is provided with a longer length as the second elastic arm portion 66b has to extend beyond the adhesive layer as well as the coverlay isolation layer, whereas the first elastic arm portion 66a only needs to extend beyond the coverlay isolation layer.

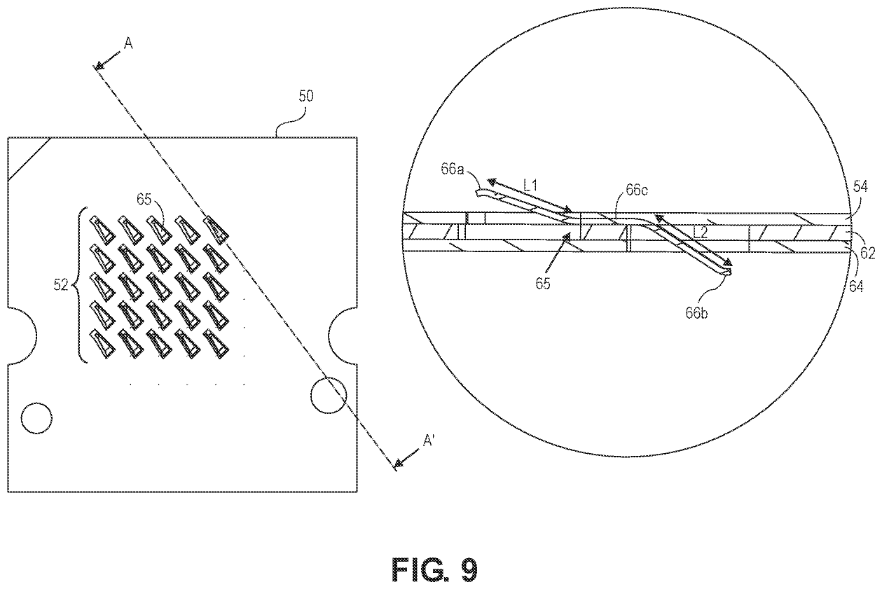

FIG. 9 illustrates a top view and an enlarged cross-sectional view of the connector 50 along a line A-A′ in some embodiments. Referring to FIG. 9, the electrical connector 50 includes an array 52 of contact elements 65. As shown in the cross-sectional view along the line A-A′, the base portion 66c of the contact element 65 is positioned on the adhesive layer 62. The first elastic arm portion 66a extends through openings in the top coverlay isolation layer 54. The second elastic arm portion 66b extends through openings in the adhesive layer 62 and the bottom coverlay isolation layer 64. The length L2 of the second elastic arm portion 66b is longer than the length L1 of the first elastic arm portion 66a. By using asymmetric elastic spring lengths, the electrical connector 50 can be constructed with a single adhesive layer which simplifies manufacturing process and reduces cost.

In this detailed description, various embodiments or examples of the present invention may be implemented in numerous ways, including as a process; an apparatus; a system; and a composition of matter. A detailed description of one or more embodiments of the invention is provided above along with accompanying figures that illustrate the principles of the invention. The invention is described in connection with such embodiments, but the invention is not limited to any embodiment. Numerous modifications and variations within the scope of the present invention are possible. The scope of the invention is limited only by the claims and the invention encompasses numerous alternatives, modifications, and equivalents. Numerous specific details are set forth in the description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured. The present invention is defined by the appended claims.

1. A connector for electrically connecting to conductive structures formed on an electronic component to be connected thereto, comprising:
a contact element layer comprising an array of contact elements, each contact element comprising a base portion and first and second elastic arm portions provided on opposing sides of the base portion, the sides of the base portion being in a direction along a planar surface of the base portion, the first and second elastic arm portions being compliant spring elements and extending in opposite first and second directions relative to the base portion, the first and second directions being perpendicular to the planar surface of the base portion.

2. The connector of claim 1, wherein each contact element has a unitary construction comprised of a single-piece conductive material.

3. The connector of claim 1, wherein the contact elements are formed from a metal layer.

4. The connector of claim 3, wherein the contact elements are formed as stamped metal springs.

5. The connector of claim 1, wherein the array of contact elements comprises a two-dimensional array of contact elements.

6. The connector of claim 1, wherein the first direction comprises an upward direction and the second direction comprises a downward direction.

7. The connector of claim 1, further comprising:
a first coverlay isolation layer attached to a first surface of the contact element layer and comprises a first plurality of openings; and
a second coverlay isolation layer attached to a second surface of the contact element layer and comprising a second plurality of openings, the second surface being opposite the first surface in a direction perpendicular to the planar surface of the contact element layer, wherein the first elastic arm portion of each contact element protrudes from a respective opening in the first plurality of openings and the second elastic arm portion of each contact element protrudes from a respective opening in the second plurality of openings.

8. The connector of claim 7, further comprising:
a first adhesive layer provided between the first coverlay isolation layer and the contact element layer to attach the first coverlay isolation layer to the contact element layer; and
a second adhesive layer provided between the second coverlay isolation layer and the contact element layer to attach the second coverlay isolation layer to the contact element layer.

9. The connector of claim 7, wherein the first plurality of openings are aligned with the second plurality of openings and wherein the first elastic arm portion of a first contact element protrudes from a first opening in the first plurality of openings and the second elastic arm portion of the first contact element protrudes from a second opening in the second plurality of openings, the second opening being adjacent to an opening in the second plurality of openings that corresponds to the first opening, the first opening and the second opening being aligned along a central line of the base portion.

10. The connector of claim 8, wherein the first elastic arm portion has a first length and the second elastic arm portion has a second length equal to the first length.

11. The connector of claim 1, wherein the first elastic arm portion is positioned on a first side of the base portion with a first offset from a central line of the base portion and the second elastic arm portion is positioned on a second side of the base portion with a second offset from the central line, the second side being opposite the first side, and the first offset being in an opposite direction from the second offset relative to the central line.

12. The connector of claim 7, further comprising:
an adhesive layer provided between the contact element layer and the second coverlay isolation layer, wherein the base portion of each contact element is attached to the adhesive layer.

13. The connector of claim 12, wherein the first elastic arm portion extends in the first direction to protrude from the first coverlay isolation layer and the second elastic arm portion extends in the second direction through the adhesive layer to protrude from the second coverlay isolation layer.

14. The connector of claim 12, wherein the first elastic arm portion has a first length and the second elastic arm portion has a second length longer than the first length.

15. The connector of claim 12, wherein the first plurality of openings are aligned with the second plurality of openings and wherein the first elastic arm portion of a first contact element protrudes from a first opening in the first plurality of openings and the second elastic arm portion of the first contact element protrudes from a second opening in the second plurality of openings, the second opening being adjacent to an opening in the second plurality of openings that corresponds to the first opening, the first opening and the second opening being aligned along a central line of the base portion.
